(19) United States
(12) Patent Application Publication
(10) Pub. No.: US 2001/0033699 A1
(43) Pub. Date: Oct. 25, 2001

(54) Very low-power parallel video processor pixel circuit

(75) Inventor: Kamran Eshraghian, Mindarie (AU)

Correspondence Address: Charles N.J. Ruggiero, Esq., Ohlandt, Greeley, Ruggiero & Perle, L.L.P., 10th Floor, One Landmark Square, Stamford, CT, 06901-2682, US

(73) Assignee: Intelligent Pixels, Inc.

(21) Appl. No.: 09/785,578

(22) Filed: Feb. 16, 2001

Related U.S. Application Data
(60) Provisional application No. 60/183,547, filed on Feb. 18, 2000.

(51) Int. Cl. G06K 9/36

(52) U.S. Cl. 382/276

(57) ABSTRACT

There is provided an image capturing and processing apparatus. The apparatus includes a plurality of image capturing and processing elements arranged in an array on a common substrate. Each of the plurality of elements includes a photodetector for detecting light that produces a signal corresponding to light incident upon the photodetector, and a processor for producing a forward discrete wavelet transform of the signal. The processor also compensates for motion represented by a change in the signal.

### CROSS REFERENCE TO RELATED APPLICATION

The present application is claiming priority of U.S. Provisional Patent Application Ser. No. 60/183,547, which was filed on Feb. 18, 2000.

### BACKGROUND OF THE INVENTION

1. Field of the Invention

The present invention relates to a video processor pixel circuit, and also to an array of such pixel circuits having a massively parallel processing capability for real-time, simultaneous image capture, in-situ processing and display of an image on a single substrate. The invention performs rapid multi-scale wavelet transforms in both the forward and reverse directions, and coding/decoding of the wavelet coefficients, to accomplish both image capture and decomposition, as well as image reconstruction and display, on the same array of pixels, at very low power and very low package pin count. The invention is capable of the simultaneous capture and display of separate video sequences on a time-division multiplexed basis.

2. Description of the Prior Art

Conventionally, liquid crystal display units have been employed exclusively for image display, wherein each display unit includes an image display composed of a liquid crystal material and a drive circuit. However, such liquid crystal displays are for display only, and are not capable of capturing an image.

Liquid crystal displays with write-in capability using a light pen or other similar device have been developed. European Patent Application 90304222.4 discloses one such liquid crystal display with a write-in capability. The write-in capability is provided by a photoconductive layer formed between an intersection of each row and column electrode line. When light projected from the light pen is incident upon one of the photoconductors, the resistance between the row and column electrode lines decreases. This decrease in resistance is then detected by circuitry external to the liquid crystal display and the position of the light pen is calculated by the external circuitry. Each pixel in the display operates independently of the other pixels, and no processing is performed by the pixel of the signal received by the photoconductor.

A similar device is described in UK Patent Application 2067812, in which a photoelectric element is provided at an intersection of each column and row electrode. The manner of operation of the device described in UK Patent Application 2067812 is similar to that described above in relation to European Patent Application 903004222.4. Similarly, in the device described in UK Patent Application 2067812, each pixel operates independently of the other pixels in the display, and no processing is performed by the pixel of the signal received by the photoelectric element.

Other examples and variations of displays are described in European Patents EP 605246, EP 394044, and U.S. Pat. No. 4,917,474.

Camera-on-a-chip, a long time goal of many developers, has been frustrated by an incompatibility between charge coupled device (CCD) technology and manufacturing techniques for mounting circuitry onto silicon. Advancements in silicon technology with new process design rules has enabled development of single chips that incorporate all camera functions, timing and control, analogue-to-digital conversion, and limited signal processing required to provide exposure control and color balance. In an imaging array, 100,000 or more pixels are laid out in a two-dimensional grid on a silicon surface. Individual pixels are addressed and accessed by a two dimensional (2D) arrangement of address and data buses, similar to the manner in which semiconductor memories are accessed. However, such camera-on-a-chip technology provides for an image-capturing device only, which is not capable of processing or displaying an image.

Research has also been conducted into “smart pixels” that include an optical detector, an electronic circuit and a modulated optical transmitter. The optical detector provides a signal to the electronic circuit, which acts upon the signal and provides a further signal to the modulated optical transmitter. The modulated optical transmitter produces a modulated optical signal representative of the signal that it received from the electronic circuit. The modulated optical transmitter is typically a light emitting diode, a semiconductor laser or a phase modulated liquid crystal. The modulated optical signal is not for viewing by a person, but is instead detected by a complex optical network. Therefore, these “smart pixels” perform some processing on a signal received by the optical detector and then retransmit the processed signal for detection by an optical network and further computation. The modulated optical transmitter is simply a convenient method of communicating the processed signal to a further processing device.

### SUMMARY OF THE INVENTION

It is an object of the present invention to provide an integrated solution for portable multimedia communication or remote monitoring applications.

It is another object of the present invention to provide an integrated device capable of image or real-time video capture, compression, decompression and display.

It is still a further object of the present invention to provide an integrated device capable of audio capture.

One embodiment of the present invention provides for an image capturing and processing apparatus. The apparatus includes a plurality of image capturing and processing elements arranged in an array on a common substrate. Each of the plurality of elements includes a photodetector for detecting light that produces a signal corresponding to light incident upon the photodetector, and a processor for producing a forward discrete wavelet transform of the signal. The processor also compensates for motion represented by a change in the signal.

Another embodiment of the present invention provides for an image processing element having a processor for producing a zerotree map from a first signal corresponding to an element of detected light, and for producing an inverse zerotree map from a second signal corresponding to a pixel of an image. The processor resides on a single substrate.

Yet another embodiment of the present invention provides for an image processing apparatus having a plurality of image processing elements arranged in an array on a common substrate. Each of the plurality of elements includes a processor for producing a forward discrete wavelet transform of a first signal corresponding to an element of detected light, and for producing an inverse discrete wavelet transform of a second signal corresponding to a pixel of an image. The processor also compensates for motion represented by a change in the first signal.

### BRIEF DESCRIPTION OF THE DRAWINGS

FIG. 1 is a block diagram of a pixel array circuit in accordance with the present invention;

FIG. 2 is a block diagram of the input stage in the pixel array circuit of FIG. 1 in accordance with the present invention;

FIG. 3 is a block diagram of the output stage in the pixel array circuit of FIG. 1 in accordance with the present invention;

FIG. 4 is a top view of a pixel array circuit in accordance with the present invention;

FIG. 5 is a block diagram of a pixel element in accordance with the present invention;

FIG. 6 is a cross-sectional diagram illustrating the physical layers that make up the combined capture, processing and display pixel element in accordance with the present invention;

FIG. 7 is a block diagram showing the architecture of the processor and the associated interconnects for four pixel elements of FIG. 5 in accordance with the present invention;

FIG. 8 is a block diagram of the significance checking architecture for determination of the significance of a wavelet coefficient in accordance with the present invention;

FIG. 9 is a block diagram showing the scale control architecture within the pixel array in accordance with the present invention;

FIG. 10 is a diagram illustrating how an MxN pixel array video processor is formed from a J×K array of nucleic blocks in accordance with the present invention; and

FIG. 11 is a diagram of an arrangement of pixel elements particularly suited for capturing and displaying color images in accordance with the present invention.

### DESCRIPTION OF THE INVENTION

The present invention provides an integrated solution for portable multimedia communication or remote monitoring applications. It is capable of image or real-time video capture and compression. It is also capable of image or real-time video decompression and display. The image or video compression and decompression is achieved through a use of an array that employs a massively parallel pixel-wise self-classifying wavelet and zerotree processing architecture. Image or video data can be directed either to a display that is integrated into the present invention or to an external device.

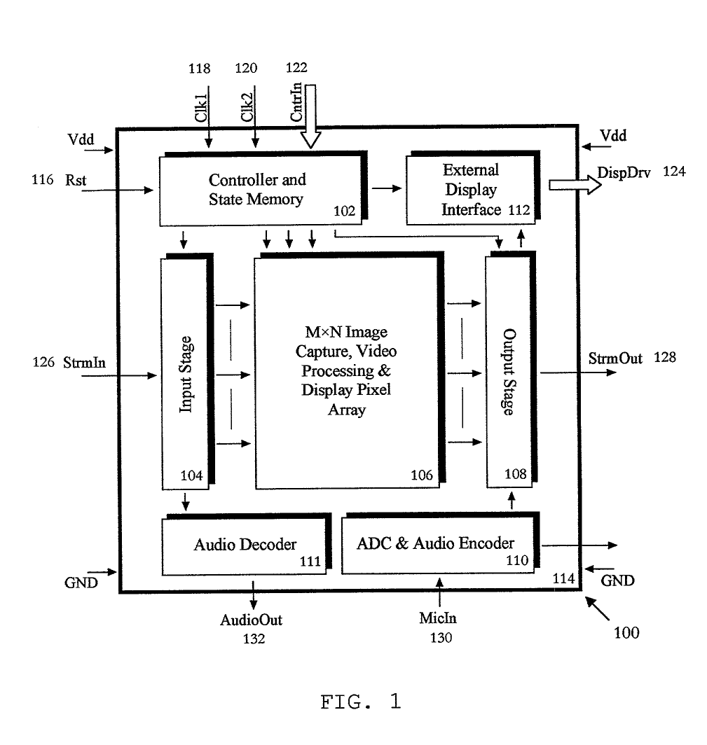

FIG. 1 is a block diagram of a pixel array circuit 100 in accordance with the present invention. Pixel array circuit 100 is a very low power, single chip solution for integrated capture and processing or integrated capture, processing and display, of real-time video at Phase Alternation Line (PAL) or National Television Standards Committee (NTSC) frame rates.

Pixel array circuit 100 includes a substrate 114 upon which are disposed one or more processors comprising a controller and state memory 102, an input stage 104, an M×N image capture, video processing and display pixel array 106, an output stage 108, an embedded analogue-to-digital converter (ADC) and audio encoder 110, an audio decoder 111 and an external display interface 112. Substrate 114 is a conventional semiconductor substrate including, but not limited to, silicon or gallium arsenide.

Controller and state memory 102 has inputs Rst 116, Clk1 118, Clk2 120 and CntrIn 122. Rst 116 causes a complete system reset. Clk1 118 is a very slow clock that provides timing signals for the M×N image capture, video processing and display pixel array 106, input stage 104, output stage 108, and controller and state memory 102. Clk2 120 is a fast clock that provides timing signals to controller and state memory 102, display interface 112, input stage 104, output stage 108, ADC and audio encoder 110, and audio decoder 111. CntrIn 122 allows input of necessary external control information such as operating mode and contrast control. Controller and state memory 102 is used to internally control the operation of all blocks within pixel array circuit 100 by outputting appropriate timing and state information. This state information defines an operating mode for the pixel array circuit 100 including, but not limited to, video/audio capture, video/audio compression, video/audio decompression, and video display.

Input stage 104 has an input StrmIn 126 that receives a data bit-stream compliant with the Motion Picture Experts Group (MPEG)-4 industry standard from another pixel array circuit 100 or other compliant device including, but not limited to, possible software emulations of the processing component of pixel array circuit 100. This input bit-stream is converted into two separate data bit-streams for input to M×N image capture, video processing and display pixel array 106 and audio decoder 111, as described in detail below.

Audio decoder 111 receives compressed audio data from input stage 104, and performs decompression on this compressed audio data. The decompressed audio signal is output via AudioOut 132.

ADC and audio encoder 110 has an input, MicIn 130, which couples a signal from an external analogue microphone or equivalent device. ADC and audio encoder 110 converts an analogue signal received via MicIn 130 to a digital representation, and performs audio compression on this digital signal. The compressed audio data are sent from ADC and audio encoder 110 to output stage 108.

M×N image capture, video processing and display pixel array 106 converts light incident upon the array into an MxN resolution digital image, and performs compression upon this captured image. The compressed image data is then output, in parallel via M data lines, to output stage 108.

M×N image capture, video processing and display pixel array 106 also receives compressed image data via M data lines from the input stage 104, decompresses this data and displays the resulting image. This image data may also be sent to output stage 108 for relaying to external display interface 112.

Output stage 108 receives separate input data from M×N image capture, video processing and display pixel array 106 and ADC and audio encoder 110. This data is converted into an MPEG-4 compliant bit-stream for output via StrmOut 128 to another pixel array circuit 100 or other compliant device including, but not limited to, possible software emulations of the processing component of pixel array circuit 100.

External display interface 112 provides an interface between the M×N image capture, video processing and display pixel array 106 and an external display device. Display interface 112 receives image data from M×N image capture, video processing and display pixel array 106 via output stage 108, and converts this to a format specified for a particular display device including, but not limited to, such devices as a personal digital assistant (PDA) display, and provides the formatted data as an output via DispDrv 124.

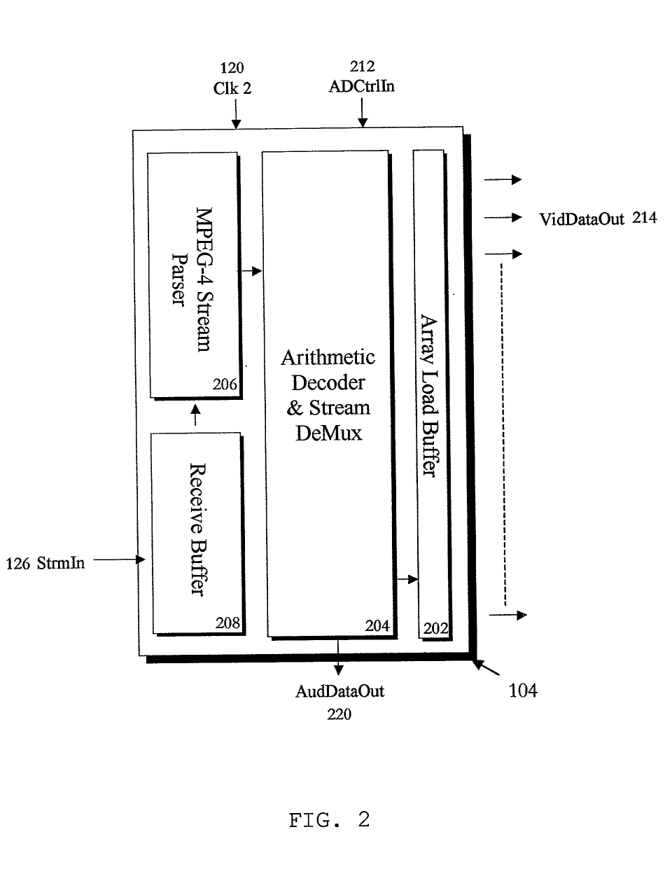

FIG. 2 is a block diagram of the input stage 104, which has inputs for Clk2 120, ADCtrlIn 212 and StrmIn 126, and outputs for audio data via AudDataOut 220, and an M sized vector of video data via VidDataOut 214. It includes a receive buffer 208, an MPEG-4 stream parser 206, an arithmetic decoder and stream demux (demultiplexer) 204 and an array load buffer 202.

ADCtrlIn 212 provides control information from the control and state memory 102 component.

Input stage 104 receives and buffers, in receive buffer 208, an input data bit-stream via StrmIn 126. The input data bit-stream is in the form of an MPEG-4 compliant bit-stream containing multiplexed compressed video and compressed audio bit-stream data as generated by another pixel array circuit 100 or other compliant device including, but not limited to, possible software emulations of the processing component of pixel array circuit 100.

MPEG-4 stream parser 206 receives the buffered data from receive buffer 208. It filters this data to remove MPEG-4 header information, and recovers the multiplexed compressed video and compressed audio data bit-stream. The multiplexed compressed video and compressed audio data bit-stream is provided to arithmetic decoder and stream demux 204.

Arithmetic decoder and stream demux 204 takes this multiplexed video and audio data bit-stream, performs arithmetic decoding and provides a decoded video bit-stream to array load buffer 202, and a decoded audio bit-stream via AudDataOut 220 to audio decoder 111, shown in FIG. 1. The arithmetic decoding process recovers a data stream that has been encoded by an equivalent arithmetic encoding process, which codes data values with a high probability of occurrence, found within an input data stream, with a minimum number of bits.

Array load buffer 202, which receives a demultiplexed and decoded video stream in serial form from arithmetic decoder and stream demux 204, provides a serial to parallel conversion of the data stream, which results in an M sized vector of video stream data. This M sized vector is delivered in parallel to MxN image capture, video processing and display pixel array 106, shown in FIG. 1, via M outputs VidDataOut 214.

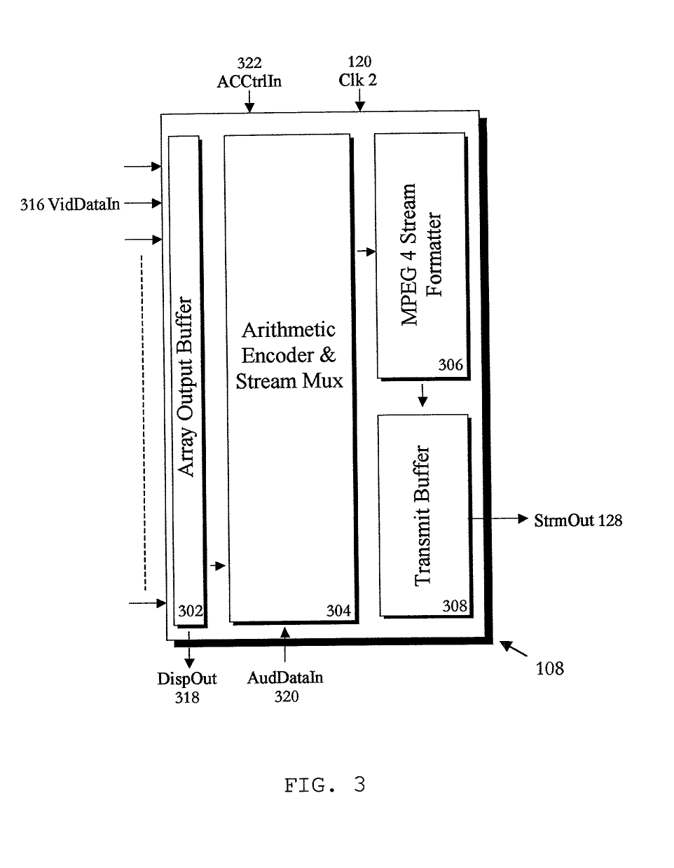

FIG. 3 is a block diagram of the Output Stage 108, which has inputs for Clk2 120, ACCtrlIn 322, audio data via AudDataIn 320, and an M sized vector of video data via VidDataIn 316. Output stage 108 has outputs for StrmOut 128 and DispOut 318.

Output Stage 108 includes an array output buffer 302, an arithmetic encoder and stream mux (multiplexer) 304, an MPEG-4 stream formatter 306, and a transmit buffer 308. The underlying function of output stage 108 is to provide an MPEG-4 compliant multiplexed and arithmetically encoded data stream via StrmOut 128, which includes an audio stream supplied by AudDataIn 320 and a video data stream supplied via VidDataIn 316.

ACCtlrIn 322 provides control information from the control and state memory 102 component.

Array output buffer 302 receives an M sized vector of video data streams in parallel via VidDataIn 316 from M×N image capture, video processing and display pixel array 106, shown in FIG. 1. The destination of the data from array output buffer 302 depends on the intended destination of the M sized vector. If the data is to be displayed on an external display device, then array output buffer 302 sends the data to DispOut 318, through which the data is coupled to external display interface 112, shown in FIG. 1. Otherwise the M sized vector is converted from parallel format to serial format and sent to the arithmetic encoder and stream mux 304.

Arithmetic encoder and stream mux 304 receives a separate serial compressed video data stream from array output buffer 302, and a separate compressed audio data stream via AudDataIn 320 from ADC and audio encoder 110, shown in FIG. 1. Arithmetic encoder and stream mux 304 multiplexes and arithmetically encodes these streams to produce an amalgamated data stream of multiplexed and coded compressed video and compressed audio data that it sends to the MPEG-4 stream formatter 306.

MPEG-4 stream formatter 306 receives the encoded video and audio streams from arithmetic encoder and stream mux 304. It provides a standard MPEG-4 encapsulating process, adding data such as the header and stream control information pertaining to the MPEG-4 standard, and passes this MPEG-4 encapsulated, multiplexed and arithmetic coded data stream to transmit buffer 308.

Transmit buffer 308 receives the MPEG-4 encapsulated data stream from MPEG-4 stream formatter 306. It buffers the stream in order to maintain a given data stream output rate and delivers this stream via StrmOut 128 to another pixel array circuit 100 or other compliant device including, but not limited to, possible software emulations of the processing component of pixel array circuit 100.

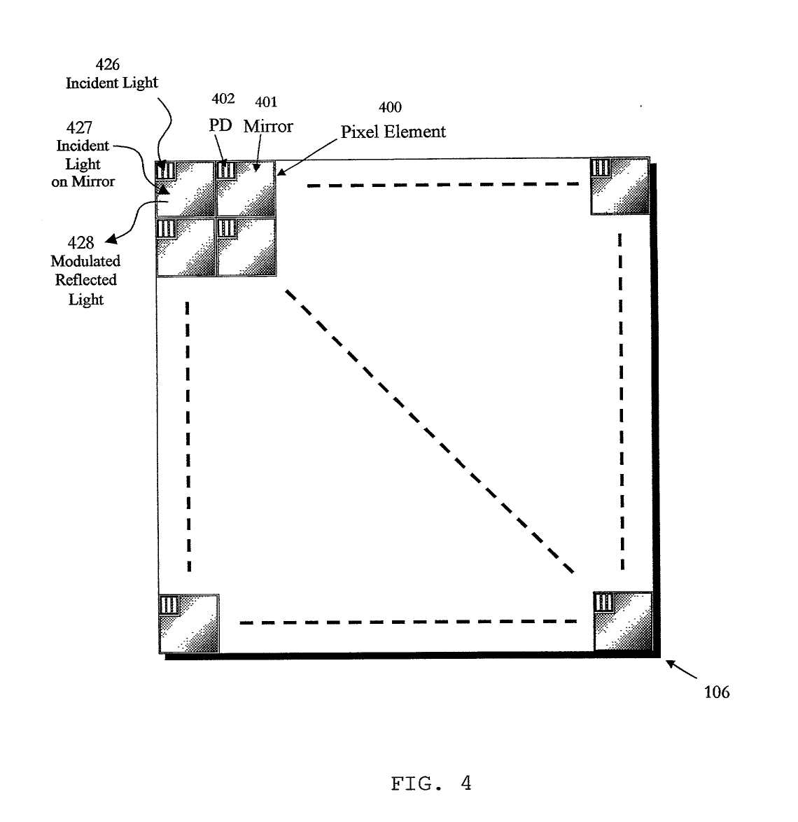

FIG. 4 is a top view of M×N image capture, video processing and display pixel array 106, which includes an array of M×N individual pixel elements 400. Each pixel element 400 in M×N image capture, video processing and display pixel array 106 contains a photo-detector device PD 402 and a mirror 401.

PD 402 captures incident light 426 and converts the light into an electronic representation. Many incident light 426 signals, i.e., those sampled by the M×N pixel elements 400, collectively represent a captured incident image.

Mirror 401 forms part of a liquid crystal display. A liquid crystal display produces an image by modulating light that is incident on the display. Accordingly, incident light 427 is modulated and reflected from mirror 401 as modulated reflected light 428 to display an M×N image over the M×N image capture, video processing and display pixel array 106.

Thus, M×N image capture, video processing and display pixel array 106 operates both to capture an incident image, and to display an image. The captured image is obtained from incident light 426 acquired by the PDs 402 in the M×N pixel elements 400. The displayed image is produced from incident light 427, which is modulated and reflected as modulated reflected light 428 by the mirrors 401 in the M×N pixel elements 400.

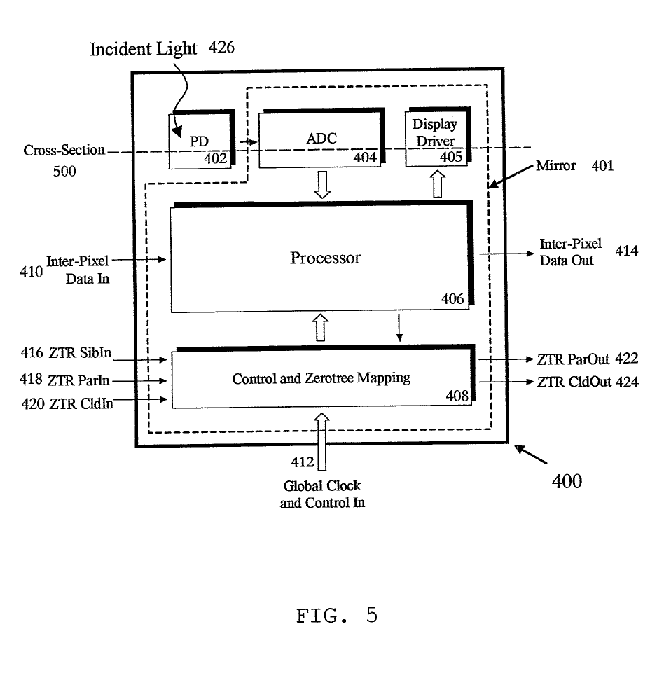

FIG. 5 is a block diagram of a pixel element 400, in accordance with the present invention. Pixel element 400 includes an analogue photo-detector (PD) 402, an analogue to digital converter (ADC) 404, a processor 406, a control and zerotree mapping component 408, a mirror 401 and a display driver 405. Pixel element 400 has inputs for Inter-Pixel Data In 410, a Global Clock and Control In 412, and Incident Light 426, and an output for Inter-pixel Data Out 414.

Inter-Pixel Data In 410 receives data signals from surrounding pixel elements 400 or from input stage 104. Global Clock and Control In 412 specifies an operating mode for pixel element 400 selected from, but not limited to, pixel-wise image capture, pixel-wise image compression, pixel-wise image decompression and pixel-wise image display. Incident light 426 is the analogue light signal incident on pixel element 400. Inter-pixel Data Out 414 sends data to surrounding pixel elements 400 or to output stage 108.

PD 402 is a photo-detector device capable of converting the incident analogue visible or infrared light signal into an equivalent analogue electrical signal. That is, it detects incident light and produces a signal corresponding to the incident light. The analogue electrical signal output of PD 402 is sent to ADC 404.

ADC 404 receives the analogue electrical signal from PD 402 and converts this signal into an equivalent digital representation. The digital signal is output from ADC 404 to processor 406.

Processor 406 receives captured image data in digital form from ADC 404 and performs motion compensation between a current captured pixel value and a previously captured pixel value stored therein. Using data from the motion compensation process, it then performs a pixel-based multi-scale wavelet decomposition, which yields a wavelet coefficient. A multi-scale wavelet decomposition is a transform commonly used to separate the components of an image into a number of frequency domains at different resolution scales in such a manner that the energy of that image is mainly localized into a small number of wavelet coefficients. A pixel element 400 based approach to wavelet transformation allows for a novel massively parallel hardware wavelet transform architecture to be realized by the M×N image capture, video processing and display pixel array 106 of pixel elements 400.

A wavelet coefficient resulting from the pixel element 400 based wavelet decomposition is quantified according to control data that processor 406 receives from control and zerotree mapping component 408. Processor 406 determines the significance of the quantified coefficient, and passes data representative thereof to control and zerotree mapping 408 component. Processor 406 may also pass the quantified wavelet coefficient to another pixel element 400 via Inter-Pixel Data Out 414.

Processor 406 may also receive a wavelet coefficient from another pixel element 400 via Inter-Pixel Data In 410. Processor 406 performs a pixel-based inverse wavelet transform operation on this wavelet coefficient to reconstruct a pixel data value. It then performs an inverse motion compensation operation on this reconstructed pixel data value along with the previously stored reconstructed pixel image value to generate a new reconstructed image value. This reconstructed image value may either be sent to another pixel element 400 via Inter-Pixel Data Out 414 or it may be delivered to display driver 405.

The aforementioned operations of processor 406 are controlled via the control and zerotree mapping 408 component.

Control and zerotree mapping component 408 is a processor that receives Global Clock and Control In signals 412, which determine the current state of operation of pixel element 400. It also receives the coefficient significance data from processor 406, and has inputs for ZTR SibIn 416, ZTR ParIn 418 and ZTR CldIn 420. ZTR SibIn 416, ZTR ParIn 418 and ZTR CldIn 420 relate to the significance of surrounding pixel elements 400 in a zerotree hierarchy. Using these inputs control and zerotree mapping component 408 codes the wavelet coefficients generated by processor 406 using a zerotree technique. The zerotree coding technique exploits the strong correlation between insignificant coefficients at the same spatial locations in different scales of a multi-resolution decomposition that result from a wavelet decomposition, and its potential for highly efficient coding of wavelet transformed images is well documented in literature concerning the art. A pixel element 400 based approach to zerotree mapping allows for a novel massively parallel hardware zerotree mapping architecture to be realized by the M×N image capture, video processing and display pixel array 106 of pixel elements 400.

The ZTR SibIn 416 signal receives significance information from pixel elements 400, which contain wavelet coefficients from the same frequency resolution scale of the wavelet decomposition. The ZTR ParIn 418 signal receives significance information from pixel elements 400, which contain wavelet coefficients from the preceding lower frequency resolution scale of wavelet decomposition. The ZTR CldIn 420 signal receives significance information from pixel elements 400, which contain wavelet coefficients from the following higher frequency resolution scale of wavelet decomposition.

Control and Zerotree Mapping component 408 has outputs for ZTR ParOut 422 and ZTRCldOut424. A signal via ZTR ParOut 422 provides significance information to the pixel element 400 that contains the wavelet coefficient from the preceding lower frequency resolution scale of wavelet decomposition. A signal via ZTR CldOut 424 sends significance information to pixel elements 400 that contain wavelet coefficients from the following higher frequency resolution scale of wavelet decomposition.

Control and zerotree mapping component 408 also generates a zerotree symbol based on the coefficient significance data from processor 406, and inputs ZTR SibIn 416, ZTR ParIn 418 and ZTR CldIn 420. It passes the zerotree symbol to processor 406 for distribution via pixel elements 400 to output stage 108. In addition control and zerotree mapping component 408 has outputs ZTR ParOut 422 and ZTR CldOut 424, which relay the significance received from processor 406, and inputs ZTR SibIn 416, ZTR ParIn 418 and ZTR CldIn 420, to surrounding pixel elements 400 in a zerotree hierarchy.

Mirror 401 is formed from a top metallization layer of the chip manufacturing process on top of the circuitry over the surface of pixel element 400. Display driver 405 drives the liquid crystal display system. That is, display driver 405 is a processor that receives image data from processor 406 and modulates incident light 427, which is, accordingly, reflected from mirror 401 as modulated reflected light 428.

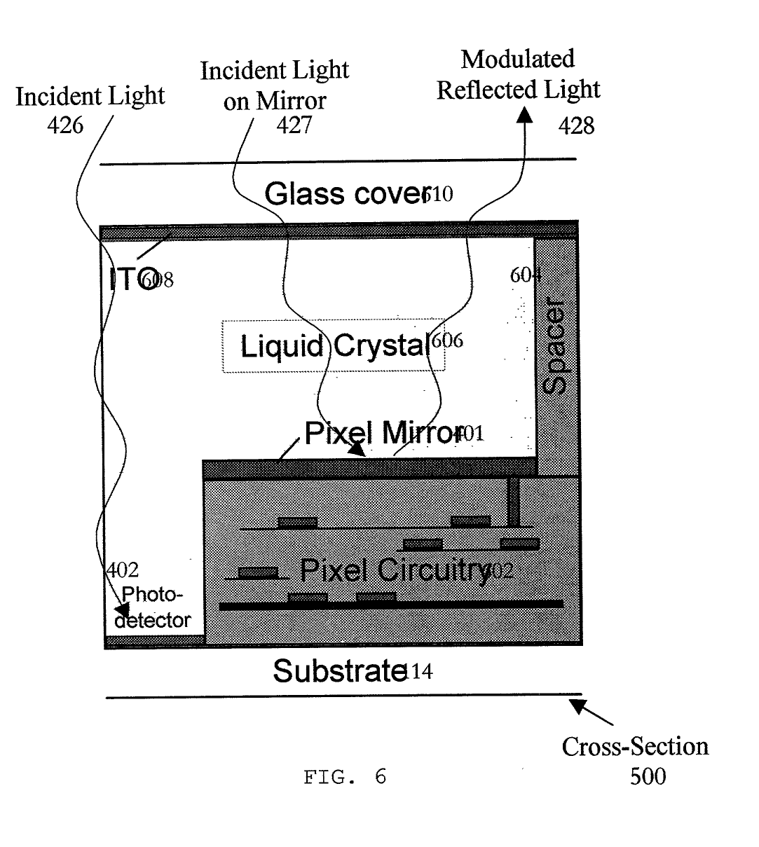

A preferred embodiment of pixel element 400 both captures and displays pixel data. For capturing pixel data, this embodiment includes PD 402 for detecting light that produces a first signal corresponding to light incident upon PD 402, processor 406 for producing a forward discrete wavelet transform of the first signal, and control and zerotree mapping component 408 for producing a zerotree map from the forward discrete wavelet transform. For displaying pixel data, this embodiment includes control and zerotree mapping component 408 for producing an inverse zerotree map from a second signal corresponding to a pixel of an image, processor 406 for producing an inverse discrete wavelet transform of the inverse zerotree map, display driver 405 for producing a display control signal from the inverse discrete wavelet transform, and a display (see FIG. 6) responsive to the display control signal to produce a visual display. PD 402, processor 406, control and zerotree mapping component 408, and display driver 405 reside on a common substrate.

A preferred embodiment of an image processing apparatus in accordance with the present invention includes a plurality of pixel elements 400 arranged in an array on a common substrate (see FIG. 4). In this embodiment, each of pixel elements includes PD 402 for detecting light that produces a first signal corresponding to light incident on PD 402, processor 406 for producing a forward discrete wavelet transform of the first signal and for compensating for motion represented by a change in the first signal. Processor 406 also produces an inverse discrete wavelet of a second signal corresponding to a pixel of an image, and compensates for motion represented by a change in the second signal. Processor 406 resides on a single substrate.

The first signal corresponds with a portion of light from a captured image. The second signal corresponds with an image to be displayed. Referring again to FIG. 1, the preferred embodiment of the image processing apparatus also includes ADC and audio encoder 110 for processing an audio signal associated with the first signal, and audio decoder 111 for processing an audio signal associated with the second signal.

FIG. 6 is a cross-sectional diagram of the physical layers that make up the combined capture, processing and display pixel element 400 taken from cross-section 500 in FIG. 5. Cross-section 500 of pixel element 400 shows the substrate 114, the photodetector (PD) 402, pixel circuitry 602, a pixel mirror 401, a spacer 604, a liquid crystal 606 layer, an indium tin oxide (ITO) 608 layer and a glass cover 610.

Layered on top of the substrate 114 are photodetector (PD) 402 and pixel circuitry 602, which are formed via conventional very large-scale integration (VLSI) semiconductor manufacturing techniques. Pixel circuitry 602 includes ADC 404, display driver 405, processor 406 and control and zerotree mapping component 408.

The top metallization layer of the semiconductor manufacturing process is used to form pixel mirror 401 over the top of pixel circuitry 602, with a hole reserved over the area of PD 402. Spacer 604 separates ITO 608 layer from pixel mirror 401 and pixel circuitry 602 to form a cavity, which is filled with liquid crystal 606. A polarized glass cover 610 is included over the ITO 608 layer.

Pixel mirror 401, liquid crystal 606, spacer 604 and class cover 610 form a display that is adjacent to the top surface of substrate 144. Liquid crystal 606 is responsive to signals from display driver 405 to produce a visual display.

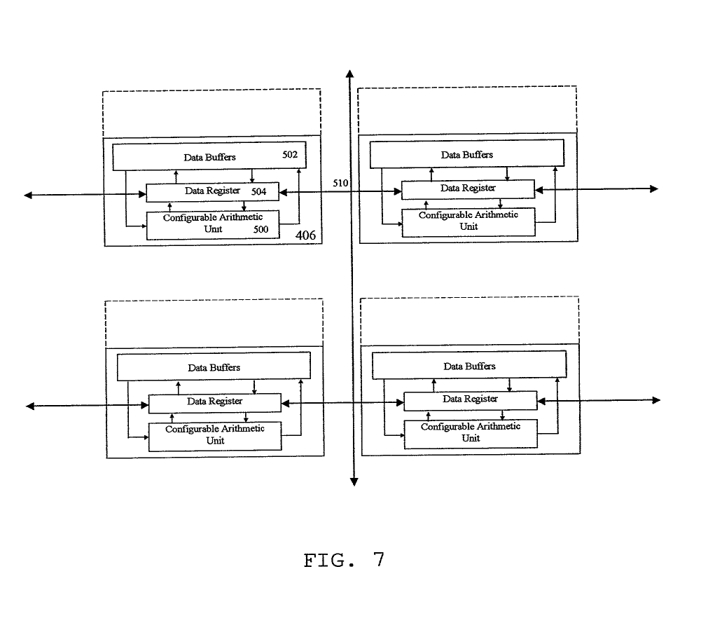

FIG. 7 is a block diagram of four processors 406 connected to each other via connection 510. Each of the four processors 406 is part of a respective pixel element 400.

Connection 510 represents connections that exist between the Inter-Pixel Data Out 414 signal of one pixel element 400 and Inter-Pixel Data In 410 in adjacent pixel elements 400 above, below, to the left, and to the right. For the pixel elements 400 in the edge adjacent to output stage 108, these connections 510 connect the Inter-Pixel Data Out 414 signals to VidDataIn 316 of output stage 108.

Connection 510 also represents connections that exist between the Inter-Pixel Data In 410 signal of one pixel element 400 and Inter-Pixel Data Out 414 in adjacent pixel elements 400 above, below, to the left, and to the right. For the pixel elements 400 in the edge adjacent to input stage 104 these connections 510 connect the Inter-Pixel Data In 410 signals to VidDataOut 214 of input stage 104.

Processor 406 includes data buffers 502, a data register 504 and a configurable arithmetic unit 500. Processor 406 can perform addition subtraction, multiplication, division, logical shifting and logical rotation operations on data from data buffers 502 or data register 504, or on data that it receives via connection 510.

Data buffers 502 store pixel data for the motion compensation process performed on the captured video data including, but not limited to, frame differencing or block searching algorithms. Data buffers 502 also store pixel data for the motion compensation process on decompressed video data received from input stage 104 including, but not limited to, frame differencing or block searching algorithms. Data buffers 502 can receive data values from data register 504 or from configurable arithmetic unit 500. Output from data buffers 502 can be delivered to data register 504 or to configurable arithmetic unit 500.

Data register 504 contains the current pixel value to be processed. It can send/receive data to/from the data buffers 502, configurable arithmetic unit 506 or via connection 510 to/from another processor 406.

Configurable arithmetic unit 506 can receive data from the data buffers 502 or data register 504. It performs arithmetic operations on this data and then delivers the result to the data buffers 502 or data register 504.

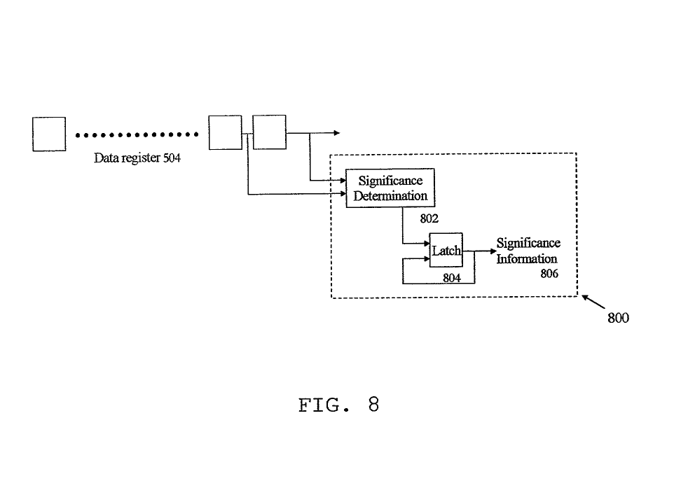

FIG. 8 is functional block diagram of a significance checking architecture 800 for determining the significance of a wavelet coefficient. A wavelet coefficient is significant if its value is greater than some threshold. Significance checking architecture 800 is a novel component of the configurable arithmetic unit 500 implemented within processor 406, shown in FIG. 7. The significance checking architecture 800 includes a significance determination 802 component and a latch 804.

In the case that data register 504 contains data representing a wavelet coefficient. The coefficient in data register 504 is shifted in a rotational manner within data register 504. Significance determination process 802 receives, as inputs, the two least significant bits of data register 504 and uses these bits to determine the significance of the coefficient in data register 504. Significance determination process 802 performs a logical operation that determines whether either of the two inputs it receives from the two least significant bits of data register 504 are not equal to each other and outputs a signal indicative thereof, which is latched in latch 804.

Latch 804 retains the status of the significance as it is checked, and outputs this as a binary value to significance information 806. Significance information 806 is thus provided from processor 406 (FIG. 4) to the control and zerotree mapping component 408 (FIG. 4).

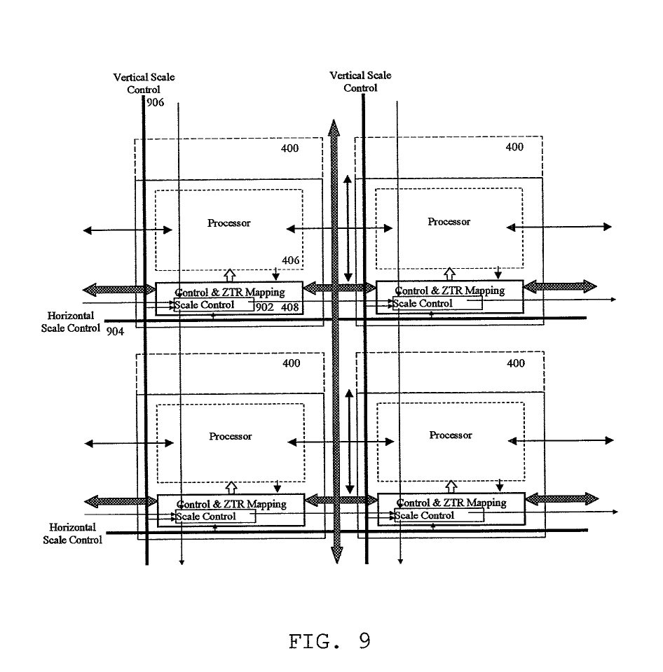

FIG. 9 is a block diagram illustrating the components of a scale control processing architecture within M×N image capture, video processing and display pixel array 106. This figure shows four pixel elements 400 that are part of M×N image capture, video processing and display pixel array 106 of pixel elements 400 organized into rows and columns. This scale control architecture is used to select which pixel elements 400 belong to a particular resolution scale of a wavelet transform.

A scale control component 902 within pixel element 400 has inputs for a horizontal scale control line 904 and a vertical scale control line 906, and determines whether the pixel element 400, of which it is a part, is enabled or disabled for the next scale iteration of a multi-scale wavelet transform.

One horizontal scale control line 904 runs across each row of pixel elements 400 and one vertical scale control line 906 runs down each column of pixel elements 400. The status of these horizontal scale control 904 and vertical scale control 906 signal lines is controlled by the controller and state memory 102 (FIG. 1) in pixel array circuit 100 (FIG. 1).

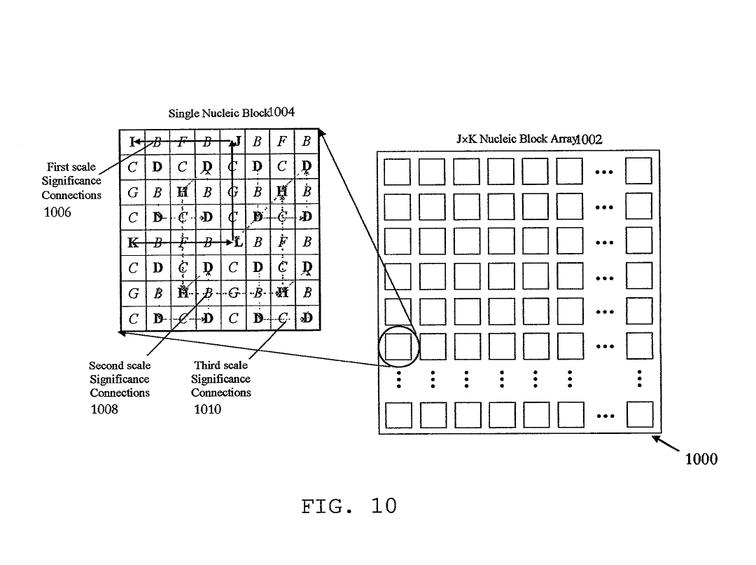

FIG. 10 is a diagram illustrating how M×N image capture, video processing and display pixel array 106 (FIG. 1) is formed from a J×K array of nucleic blocks 1002. A nucleic block 1004 is a 2^{S}×2^{S} array of pixel elements 400, where S is the number of scales over which the wavelet transform is performed. A nucleic block 1004 contains a complete set of spatially related frequency components resulting from a multi-scale wavelet decomposition operation.

FIG. 10 shows the coefficients that make up each of these frequency components, for the example of a 3-scale decomposition, arranged in a manner whereby the coefficients labeled I, J, K and L belong to the lowest frequency scale, the coefficients labeled F, G and H belong to the middle frequency scale and the coefficients labeled B, C and D belong to the highest frequency scale. For the purposes of illustration, FIG. 10 also shows one set of the interconnections that are required between frequency components to convey significance information for the zerotree mapping architecture.

The first scale significance connections 1006 illustrate the connections between the low frequency components I, J, K and L. The second scale significance connections 1008 illustrate the connections between the middle frequency components H and the low frequency components L. The third scale significance connections 1010 illustrate the connections between the high frequency components D and the corresponding middle scale frequency components H. Connections between C and G, B and F, G and K, and F and J are also required, though not shown.

In addition to grayscale, the architecture described herein is also applicable for the capture, processing and display of color video. For the capture of color video, PD 402 includes a first detector portion responsive to light of a first frequency, a second detector portion responsive to light of a second frequency and a third detector portion responsive to light of a third frequency. Thus, PD 402 produces signals corresponding to light incident upon the first, second and third detector portions. ADC 404 multiplexes conversion of the separate electrical signals generated by each of these separate portions of the photodetector and delivers a corresponding digital value to processor 406 for each signal.

Thus, an alternate embodiment of pixel element 400 includes a plurality of PD 402, each of which produce an analog signal corresponding to light incident upon a respective PD 402, and an ADC 404 for selectively converting each of the analog signals to a corresponding digital signal. The plurality of PDs 402 and ADC reside on a common substrate.

In another alternate embodiment, pixel element 400 includes PD 402 for detecting light incident upon PD 402 having a first detector portion that produces a first signal corresponding to light of a first frequency band, a second detector portion that produces a second signal corresponding to light of a second frequency band, and a third detector portion that produces a third signal corresponding to light of a third frequency band. Processor 406 and ADC 404 cooperatively provide for space division multiplexing of the first signal, the second signal and the third signal. PD 402, ADC 404 and processor 406 reside on a common substrate.

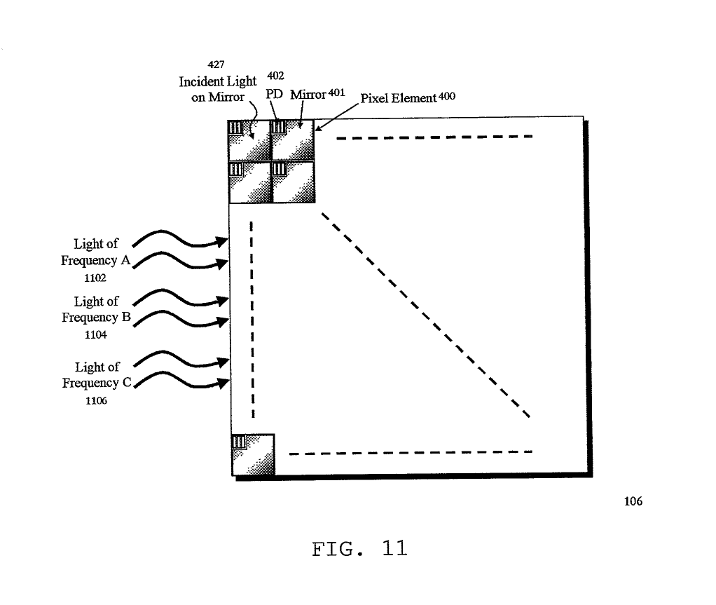

FIG. 11 is a diagram of an arrangement of pixel elements particularly suited for capturing and displaying color images. Light of frequency A 1102, light of frequency B 1104 and light of frequency C 1106 are produced from an external light source (not shown) including, but not limited to, light emitting diodes. The external light source is strobed by external display interface 112 via DispDrv 124, such that M×N image capture, video processing and display pixel array 106 is illuminated by each frequency in turn repetitively i.e., ON and OFF, at a rate controlled by control and state memory 102. To display the decompressed color video, each of the separately decompressed frequency components A, B and C are displayed in turn, synchronized with an illumination by the corresponding strobed light source with frequency A, B or C.

This technique can be realized in pixel element 400 by recognizing that an inverse discrete wavelet transform includes a light frequency component. Display driver 405 causes illumination of a light source in a display corresponding to the light frequency component.

It should be understood that various alternatives and modifications of the present invention can be devised by those skilled in the art. The present invention is intended to embrace all such alternatives, modifications and variances that fall within the scope of the appended claims.

What is claimed is:

1. An image capturing and processing apparatus comprising:
a plurality of image capturing and processing elements arranged in an array on a common substrate, wherein each of said plurality of elements includes a photodetector for detecting light that produces a signal corresponding to light incident upon said photodetector, and a processor for producing a forward discrete wavelet transform of said signal; and
a processor for compensating for motion represented by a change in said signal.

2. An image capturing and processing element comprising:
a photodetector for detecting light that produces a signal corresponding to light incident upon said photodetector;
a processor for producing a forward discrete wavelet transform of said signal; and
a processor for producing a zerotree map from said forward discrete wavelet transform,
wherein said photodetector, said processor for producing said forward discrete wavelet transform and said processor for producing said zerotree map reside on a common substrate.

3. An image capturing and processing apparatus comprising a plurality of image capturing and processing elements as recited in claim 2, arranged in an array on said substrate.

4. The image capturing and processing apparatus of claim 3, further comprising a processor for compensating for motion represented by a change in said signal.

5. An image processing element comprising:
a processor for producing a forward discrete wavelet transform of a signal corresponding to an element of detected light; and
a processor for producing a zerotree map from said forward discrete wavelet transform,
wherein said processor for producing said forward discrete wavelet transform and said processor for producing said zerotree map reside on a common substrate.

6. An image processing apparatus comprising a plurality of image processing elements as recited in claim 5, arranged in an array on said substrate.

7. The image processing apparatus of claim 6, further comprising a processor for compensating for motion represented by a change in said signal.

8. An image processing element comprising:
a processor for producing an inverse zerotree map from a signal corresponding to a pixel of an image; and
a processor for producing an inverse discrete wavelet transform of said inverse zerotree map,
wherein said processor for producing said inverse zerotree map and said processor for producing said inverse discrete wavelet transform reside on a common substrate.

9. An image processing apparatus comprising a plurality of image processing elements as recited in claim 8, arranged in an array on said substrate.

10. The image processing apparatus of claim 9, further comprising a processor for compensating for motion represented by a change in said signal.

11. An image processing element comprising:
a processor for producing an inverse zerotree map from a signal corresponding to a pixel of an image;
a processor for producing an inverse discrete wavelet transform of said inverse zerotree map; and
a processor for producing a display control signal of said inverse discrete wavelet transform,
wherein said processor for producing said inverse zerotree map, said processor for producing said inverse discrete wavelet transform and said processor for producing said display control signal reside on a common substrate.

12. The image processing element of claim 11, further comprising display means responsive to said display control signal to produce a visual display.

13. The image processing element of claim 12, wherein said display means is adjacent to a surface of said substrate.

14. The image processing element of claim 12, wherein said display means comprises a liquid crystal display.

15. An image processing apparatus comprising a plurality of image processing elements as recited in claim 11, arranged in an array on said substrate.

16. The image processing apparatus of claim 15, further comprising display means responsive to said display control signals from said plurality of elements to produce a visual display.

17. The image processing apparatus of claim 16, wherein said display means is adjacent to a surface of said substrate.

18. The image processing apparatus of claim 16, wherein said display means comprises a liquid crystal display.

19. The image processing apparatus of claim 15, further comprising a processor for compensating for motion represented by a change in said signal.

20. An image processing element comprising:
a processor for producing an inverse discrete wavelet transform of a signal corresponding to a pixel of an image; and
a processor for producing a display control signal of said inverse discrete wavelet transform,
wherein said processor for producing said inverse discrete wavelet transform and said processor for producing said display control signal reside on a common substrate.

21. The image processing element of claim 20, further comprising display means responsive to said display control signal to produce a visual display.

22. The image processing element of claim 21, wherein said display means is adjacent to a surface of said substrate.

23. The image processing element of claim 21, wherein said display means comprises a liquid crystal display.

24. An image processing apparatus comprising a plurality of image processing elements as recited in claim 20, arranged in an array on said substrate.

25. The image processing apparatus of claim 24, further comprising a processor for compensating for motion represented by a change in said signal.

26. The image processing apparatus of claim 24, further comprising display means responsive to said display control signals from said plurality of elements to produce a visual display.

27. The image processing apparatus of claim 26, wherein said display means is adjacent to a surface of said substrate.

28. The image processing apparatus of claim 26, wherein said display means comprises a liquid crystal display.

29. An image processing element comprising:
a processor for producing an inverse zerotree map from a signal corresponding to a pixel of an image;
a processor for producing an inverse discrete wavelet transform of said inverse zerotree map; and
a processor for producing a display control signal of said inverse discrete wavelet transform,
wherein said processor for producing said inverse zerotree map, said processor for producing said inverse discrete wavelet transform and said processor for producing said display control signal reside on a common substrate.

30. The image processing element of claim 29, further comprising display means responsive to said display control signal to produce a visual display.

31. The image processing element of claim 30, wherein said display means is adjacent to a surface of said substrate.

32. The image processing element of claim 30, wherein said display means comprises a liquid crystal display.

33. An image processing apparatus comprising a plurality of image processing elements as recited in claim 29, arranged in an array on said substrate.

34. The image processing apparatus of claim 33, further comprising a processor for compensating for motion represented by a change in said signal.

35. An image processing element comprising:
a processor for producing a zerotree map from a first signal corresponding to an element of detected light; and
a processor for producing an inverse zerotree map from a second signal corresponding to a pixel of an image,
wherein said processor for producing said zerotree map and said processor for producing said inverse zerotree map reside on a single substrate.

36. An image processing apparatus comprising a plurality of image processing elements as recited in claim 35, arranged in an array on said substrate.

37. An image processing apparatus comprising:
a plurality of image processing elements arranged in an array on a common substrate, wherein each of said plurality of elements includes a processor for producing a forward discrete wavelet transform of a first signal corresponding to an element of detected light, and a processor for producing an inverse discrete wavelet transform of a second signal corresponding to a pixel of an image; and
a processor for compensating for motion represented by a change in said first signal.

38. An image processing apparatus comprising:
a plurality of image processing elements arranged in an array on a common substrate, wherein each of said plurality of elements includes a processor for producing a forward discrete wavelet transform of a first signal corresponding to an element of detected light, and a processor for producing an inverse discrete wavelet transform of a second signal corresponding to a pixel of an image; and
a processor for compensating for motion represented by a change in said second signal.

39. An image capturing, processing and displaying element, comprising:
a photodetector for detecting light that produces a first signal corresponding to light incident upon said photodetector;
a processor for producing a forward discrete wavelet transform of said first signal;
a processor for producing a zerotree map from said forward discrete wavelet transform;
a processor for producing an inverse zerotree map from a second signal corresponding to a pixel of an image;
a processor for producing an inverse discrete wavelet transform of said inverse zerotree map;
a processor for producing a display control signal from said inverse discrete wavelet transform; and
display means responsive to said display control signal to produce a visual display,
wherein said photodetector, said processor for producing said forward discrete wavelet transform, said processor for producing said zerotree map, said processor for producing said inverse zerotree map, and said processor for producing said inverse discrete wavelet transform reside on a common substrate.

40. The image capturing, processing and displaying element of claim 39, wherein said display means is adjacent to a surface of said substrate.

41. An image capturing, processing and displaying apparatus, comprising a plurality of image capturing, processing and displaying elements as recited in claim 39, arranged in an array on said substrate.

42. The image capturing, processing and displaying apparatus of claim 41, further comprising:
a processor for compensating for motion represented by a change in said first signal; and
a processor for compensating for motion represented by a change in said second signal.

43. The image capturing, processing and displaying apparatus of claim 41, further comprising a processor for processing an audio signal associated with said first signal.

44. The image capturing, processing and displaying apparatus of claim 41, further comprising a processor for processing an audio signal associated with said second signal.

45. An image capturing element comprising:
a plurality of photodetectors each of which produce an analog signal corresponding to light incident upon said respective photodetector; and
an analog to digital converter for selectively converting each of said analog signals to a corresponding digital signal,
wherein said plurality of photodetectors and said analog to digital converter reside on a common substrate.

46. An image capture apparatus comprising a plurality of image capturing elements as recited in claim 45, arranged in an array on said substrate.

47. An image capturing element comprising:
a photodetector for detecting light incident upon said photodetector having a first detector portion that produces a first signal corresponding to light of a first frequency band, a second detector portion that produces a second signal corresponding to light of a second frequency band, and a third detector portion that produces a third signal corresponding to light of a third frequency band; and
a processor for space division multiplexing said first signal, said second signal and said third signal,
wherein said photodetector and said processor for space division multiplexing reside on a common substrate.

48. An image capturing apparatus comprising a plurality of image capturing elements as recited in claim 47, arranged in an array on said substrate.

49. The image processing element of claim 11,
wherein said inverse discrete wavelet transform includes a light frequency component, and
wherein said processor for producing said display control signal causes illumination of a light source corresponding to said light frequency component.

50. The image processing element of claim 20,
wherein said inverse discrete wavelet transform includes a light frequency component, and
wherein said processor for producing said display control signal causes illumination of a light source corresponding to said light frequency component.

51. The image processing element of claim 29,
wherein said inverse discrete wavelet transform includes a light frequency component, and
wherein said processor for producing said display control signal causes illumination of a light source corresponding to said light frequency component.

52. The image capture, processing and display element of claim 39,
wherein said inverse discrete wavelet transform includes a light frequency component, and
wherein said processor for producing said display control signal causes illumination of a light source in said display means corresponding to said light frequency component.
